(19) United States
(12) Patent Application Publication
(10) Pub. No.: US 2016/0274609 A1
(43) Pub. Date: Sep. 22, 2016

(54) CLASSIFYING UTILITY CONSUMPTION OF CONSUMERS

(71) Applicant: Onzo Limited, London (GB)

(72) Inventors: William Edward SIDDALL, London (GB); Alexander James ROBSON, London (GB)

(21) Appl. No.: 14/662,107

(22) Filed: Mar. 18, 2015

(51) Int. Cl. G05F 1/66; G05B 15/02

(52) U.S. Cl. CPC G05F 1/66; G05B 15/02

(57) ABSTRACT

A method of classifying consumption of at least one utility by a plurality of consumers acquires, or determines, a plurality of utility consumption metrics. Each utility consumption metric has a value which is indicative of an aspect of consumption by one of the plurality of consumers over a single time period or across multiple time periods within a larger time frame. The method sorts the plurality of utility consumption metrics according to metric value. The method forms clusters of the sorted utility consumption metrics to identify boundaries between the clusters of the sorted utility consumption metrics. The boundaries between the clusters of the sorted utility consumption metrics define different classes of utility consumption by the consumers and divide the consumption metrics of the consumers into the different classes.

### BACKGROUND

There is an ongoing and urgent need to reduce consumption of electricity, gas and water both for environmental and cost reasons.

A large proportion of the electrical energy, gas and water supplied by utility suppliers is wasted as a result of inefficiencies such as use of electrical appliances that have poor efficiency or for behavioural reasons such as appliances that are left switched on and so consume electricity even when not in use. This leads to wastage and increased utilities costs. Demand for utilities can vary dramatically between identical and similar buildings with the same number of occupants, and this suggests a need to reduce waste through behavioural efficiency.

A paper “Application of Clustering Algorithms and Self-Organising Maps to Classify Electricity Customers”, Gianfranco Chicco et al, IEEE Bologna Power Tech Conference, Jun. 23-26, 2003, describes classification of non-residential electricity customers. The method uses a representative load diagram of each customer.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the disclosure provides a method of classifying consumption of at least one utility by a plurality of consumers, the method comprising: acquiring or determining a plurality of utility consumption metrics, wherein each utility consumption metric has a value which is indicative of an aspect of consumption by one of the plurality of consumers over a single time period or across multiple time periods within a larger time frame; sorting the plurality of utility consumption metrics according to metric value; forming clusters of the sorted utility consumption metrics to identify boundaries between the clusters of the sorted utility consumption metrics; wherein the boundaries between the clusters of the sorted utility consumption metrics define different classes of utility consumption by the consumers and divide the consumption metrics of the consumers into the different classes.

The acquiring may comprise receiving utility consumption data for a plurality of consumers; and calculating utility consumption metrics based on the utility consumption data, wherein each utility consumption metric has a value which is indicative of an aspect of consumption by one of the plurality of consumers over a single time period or across multiple time periods within a larger time frame.

The method may further comprise notifying the consumers of the class of their utility consumption metric.

The method may further comprise performing an action for a consumer based on the class of their utility consumption metric.

The method may further comprise designating one of the boundaries as a benchmark consumption.

The method may further comprise performing additional processing for a consumer based on the class of their utility consumption metric relative to the benchmark consumption.

The method may further comprise performing analysis of utility consumption data based on the class of a consumer's utility consumption metric relative to the benchmark consumption.

The forming of clusters may use an unsupervised learning algorithm, such as K-mean clustering.

The method may further comprise applying a class identifier to each class of the utility consumption metrics.

The metric may be indicative of one of: an amount of consumption in a time period; variance of consumption across multiple time periods within a larger time frame; ratio of consumption between time periods within a larger time frame; a time period of consumption within a larger time frame; a rate of change of consumption across multiple time periods within a larger time frame; ratio of consumption between different utilities in a time period; proportion of total utility consumption in a time period which is of a particular utility.

The method may further comprise initially identifying a group of consumers, wherein the plurality of utility consumption metrics are for the group of consumers.

The method may further comprise acquiring or determining a plurality of utility consumption metrics per consumer, wherein each utility consumption metric has a value which is indicative of a different aspect of consumption by the consumer over a single time period or across multiple time periods within a larger time frame; wherein the sorting of the plurality of utility consumption metrics and the forming clusters of the sorted utility consumption metrics is performed for a data set comprising a first of the utility consumption metrics per consumer to derive classes of utility consumption for the first metrics, and repeated for a data set comprising a second of the utility consumption metrics per consumer to derive classes of utility consumption for the second metrics. The method can be applied to a larger number of metrics per consumer.

The method may further comprise determining an overall class of utility consumption per consumer based on the class of utility consumption for the first metric and on the class of utility consumption for the second metric.

The utility may be at least one of: electricity, gas and water.

Another aspect provides apparatus for classifying consumption of at least one utility by a plurality of consumers, the apparatus comprising a processor and a memory, the memory containing instructions executable by the processor whereby the processor is operative to: acquire or determine a plurality of utility consumption metrics, wherein each utility consumption metric has a value which is indicative of an aspect of consumption by one of the plurality of consumers over a single time period or across multiple time periods within a larger time frame; sort the plurality of utility consumption metrics according to metric value; form clusters of the sorted utility consumption metrics to identify boundaries between the clusters of the sorted utility consumption metrics; wherein the boundaries between the clusters of the sorted utility consumption metrics define different classes of utility consumption by the consumers and divide the consumption metrics of the consumers into the different classes.

The functionality described here can be implemented in hardware, software executed by a processing apparatus, or by a combination of hardware and software. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to perform the required functions. Another aspect of the invention provides machine-readable instructions (software) which, when executed by a processor, perform any of the described methods. The machine-readable instructions may be stored on an electronic memory device, hard disk, optical disk or other machine-readable storage medium. The machine-readable medium can be a non-transitory machine-readable medium. The term “non-transitory machine-readable medium” comprises all machine-readable media except for a transitory, propagating signal. The machine-readable instructions can be downloaded to the storage medium via a network connection.

Classifying utility consumption of consumers can help to effectively manage utility consumption. For example, effective classification of a consumer as being a high peak time electricity user could enable targeted energy management actions to be taken, such as active control of the consumer's appliances.

An advantage of at least one example of this disclosure is that it can help to more clearly and/or accurately identify which class of consumption a particular consumer falls into compared to, for example, use of fixed boundaries to separate classes.

Consumers with particularly high usage can be targeted with technical assistance such as improved insulation and more efficient appliances, or education to change their consumption behaviour.

The term “consumer” can comprise a premises, such as a household or business at which a meter is fitted.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 shows an example system to collect and process utility consumption data;

FIG. 2 shows a utility consumption/load profile and deriving a utility consumption metric;

FIG. 3 shows an example method of identifying classes of consumption of a utility;

FIG. 4 shows an example table of utility consumption metric values;

FIG. 5 shows the metric values of FIG. 4 after processing;

FIG. 6 shows an example method of identifying classes of consumption of a utility using multiple metrics per consumer;

FIG. 7 shows an example of k-means clustering;

FIG. 8 shows apparatus for a computer-based implementation of the method.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

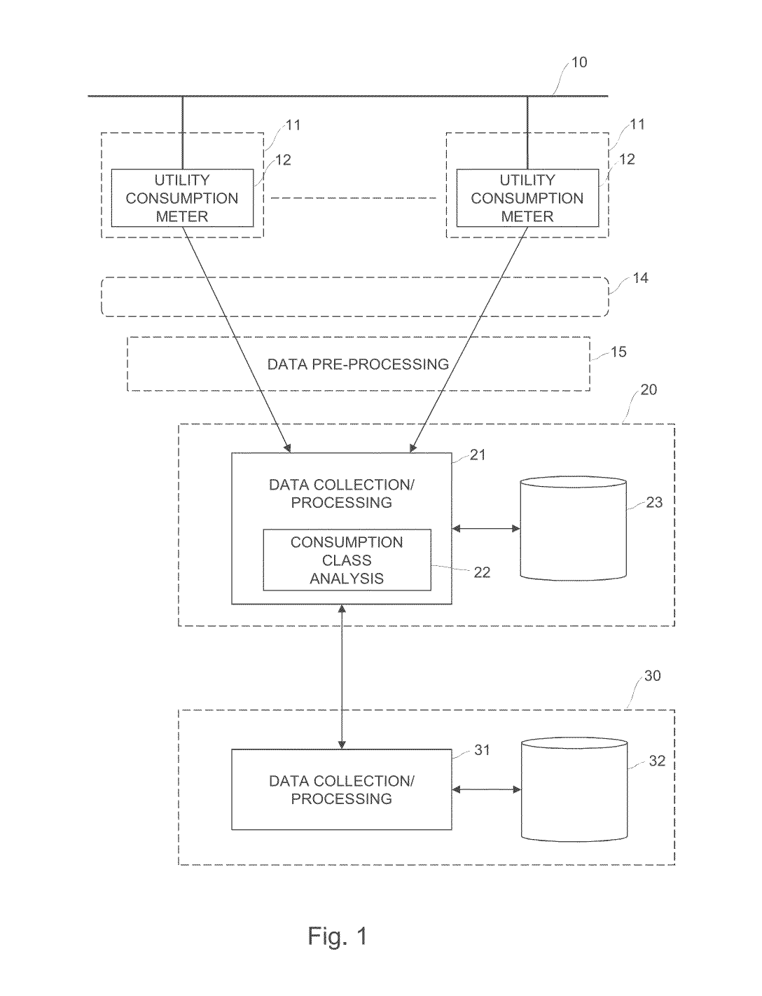

FIG. 1 shows an example system to collect and process utility consumption data. Examples are described in respect of electricity, although it will be appreciated that the utility could be another utility such as water or gas. A utility (e.g. electricity supply) is distributed 10 to a plurality of consumer premises 11. There is a utility consumption meter 12 at each premises which is configured to detect and record utility consumption at the premises 11. In the case of electricity, the unit of measurement is typically a Kilowatt hour (kWhr). The meter 12 may calculate consumption at regular intervals, such as once per second. The meter calculates a running total of energy consumed over a period of time, such as every 512 seconds, 2048 seconds or 86,400 seconds (24 hours). These measurements can also be used to determine statistically derived values such as minimum, maximum, standard deviation energy consumption over one of these longer time periods. The meter may measure real and reactive power.

The data measured at the meter 12 may be communicated to a user at the premises 11, such as via a display or user interface. The data measured at the meter 12 is communicated to a data center 20. Data may be communicated via a wireless and/or wired network 14. Optionally, data may be pre-processed 15. Pre-processing can comprise aggregation of utility consumption data or disaggregation of utility consumption data to present one or multiple time-series streams at the level of appliance, circuit, premises, and/or group of premises. The data center 20 can comprise a data collection/processing unit 21 and a store 23 for storing utility consumption data and/or utility consumption metrics. One function 22 of the processing unit 21 is to perform analysis of the utility consumption data to identify classes of consumption. For example, the classes may identify three consumption classes of users: high consumption, medium consumption and low consumption. Data and/or results of processing performing at the data center 20 can be communicated via a computer interface to another data center 30, IT system or directly to the customer for further processing. The data center 30 can comprise a data collection/processing unit 31 and a store 32 for storing data.

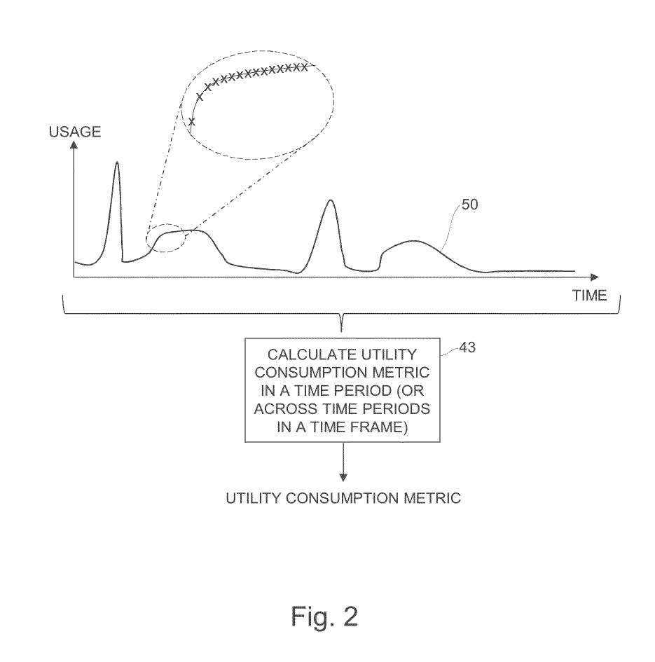

Before describing a method of identifying consumption classes, it is helpful to describe utility consumption data and metrics. FIG. 2 shows an example of a consumption profile, or a load profile 50 of a particular consumer. This indicates consumption over a period of time. For example, the profile may record consumption (in kWhr) versus time. The profile comprises a sequence of measurement values. The measurement values may be obtained at regular intervals, e.g. once per second. A utility consumption metric is derived from this profile. The utility consumption metric is indicative of an aspect of consumption by one of the plurality of consumers over a time period. The utility consumption metric has a value, such as a single numerical value. In one non-limiting example, the utility consumption metric may indicate an amount of consumption over a time period (e.g. 24 hours), such as a mean consumption over a time period or total consumption over a time period (e.g. 24 hours, week, month, seasonal period). The metric provides a useful measure of a consumer's consumption while also helping to simplify subsequent calculations. Mean consumption can be calculated by summing individual sample values and dividing by the total number of samples over the time period. Total consumption can be calculated by summing individual sample values over the time period.

One possible advantage of using single value metrics is that the subsequent clustering and classifying method can be less susceptible to outliers compared to, for example, operating upon a data set which uses a load profile of the type shown as 50, FIG. 2.

Other possible metrics include metrics which are indicative of: variance of consumption across time periods in a larger time frame; a rate of change of consumption across time periods within a larger time frame (this can also be called a “trend in consumption”); ratio of consumption between two or more time periods; and time period of consumption at a particular level within a larger time frame. Variance, or variability, indicates how consistent the customer's consumption is from one time period to the next. Consider an example where customer 1 has consumption over seven days of 5, 5, 5, 6, 5, 4, 5 and customer 2 has 1, 9, 5, 3, 12, 1, 1. Customer 1 has low variability and customer 2 has high variability. Trend indicates a change in consumption over a time frame. Consider an example where a customer has consumption over time periods=1, 2, 3, 4, 5, 6, 7. The trend is of consumption increasing by 1 unit per time period. Ratios of consumption indicate how consumption compares between two or more time periods. Consider an example where a customer has consumption over seven days, commencing on Monday=2, 2, 2, 2, 2, 10, 10. The ratio of consumption between weekday and weekend consumption is 10:20. Time of consumption metrics indicate when a particular criterion of consumption was achieved, such as peak (maximum) consumption or minimum consumption. Consider an example where a customer has consumption over seven time periods=1, 4, 8, 3, 2, 7, 4. A metric for period with highest consumption would be determined to be period 3. Other non-limiting examples of metrics include minimum, maximum, mean, mode, median, standard deviation and kurtosis.

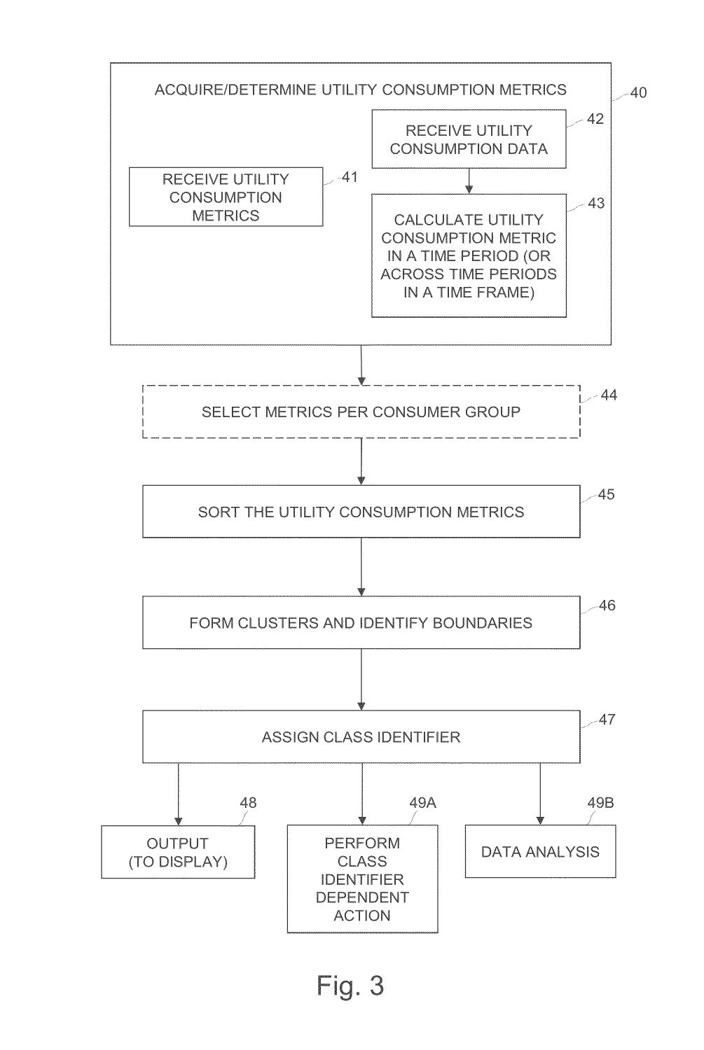

FIG. 3 shows an example of a method of identifying classes of consumption of a utility. The method may be implemented as an analytical software program which is executed by the processing unit 21 (FIG. 1) or by another processing entity in a system. At block 40 utility consumption metrics are acquired or determined Although consumption data is likely to be received from a meter, in other implementations it may be received from another system or manually entered. The metrics may be received 41 directly from a meter or another processing unit in the system. Alternatively, the metrics may be calculated at the processing unit by blocks 42, 43. Block 42 receives utility consumption data, such as consumption values defining a load profile of the type shown in FIG. 2. Block 43 calculates a utility consumption metric for a required time period, or across multiple time periods within a larger time frame. In one non-limiting example, the metric may be mean consumption per 24-hour period.

Optionally, at block 44 consumption metrics are selected for a particular group of consumers. Non-limiting examples of consumer groups are: age; gender; geographic location; employment type; property construction material. Subsequent blocks 45-49 are performed for metrics for a particular consumer group, e.g. metrics from consumers in a particular geographic location, or for all consumers. Block 44 may be located within block 40, or before 40, and act as a pre-filter of utility consumption metrics or utility consumption data arriving into block 40.

Block 45 sorts the utility consumption metrics. The sorting order can by example be order of increasing value, or order of decreasing value.

Block 46 forms clusters of the sorted utility consumption metrics. Various clustering techniques are possible. The clustering can use an unsupervised learning technique, such as k-means clustering. Clustering forms clusters, or groups, of data values. The clustering operation helps to identify boundaries between metric values. Boundaries are identified based on the clusters. For example, a boundary can be defined between two distinct clusters of metrics. The position of the boundary may be based on data values in the two clusters on each side of the boundary. For example, the boundary may be positioned mid-way between the highest metric value in a first cluster and the lowest metric value in the next, adjacent, cluster. Consider an example with two adjacent clusters: a first cluster having metric values [1, 2, 3, 4, 5, 6] and a second cluster having metric values [16, 17, 18, 19, 20, 21]. The highest metric value in the first cluster is “6” and the lowest metric value in the second cluster is “16”. The boundary between the clusters can be calculated as (6+16)/2=11. More generally, the boundary could be the mid-point, or could be the end value of the adjacent clusters. In this example, the boundary could be selected as 6 (the highest value in the first cluster), 11 (the mid-point between the first cluster and the second cluster) or 16 (the lowest value in the second cluster). Selecting the end value of one of the adjacent clusters can define an efficient level of consumption. The boundaries between the clusters of the sorted utility consumption metrics define different classes of utility consumption by the consumers and divide the consumption metrics of the consumers into the different classes.

Block 47 assigns a class identifier to each class. For example, metrics spread across three classes may have the labels: low, medium and high. Metrics spread across four classes may have the labels: low, below average, above average and high, or some other label. The “label” does not have to be a word, but could be a numerical value if subsequent processing of the data is performed by a computer.

One of the classes can represent an efficient consumer. The boundary between that class and the neighbouring class can be defined as the benchmark for an efficient utility consumption level.

The classified data is output at block 48. One possible form of output is to a display at the processing unit (21, FIG. 1). The classified data can be stored and/or sent to another network entity, such as data center 30. Having identified that consumption of a consumer falls into a particular class, that consumer can be notified of the class of consumption. The classification serves as a useful benchmark against other consumers. The notification can be via electronic communication (e.g. via a communication link to a smart meter 12 at the premises 11) or via another mechanism, such as email communication to the consumer, or a notification accompanying a consumption bill or consumption statement. The classification assigned at block 47 may be used to trigger further data analysis of the utility consumption data.

The classification assigned at block 47 may invoke a class identifier dependent action 49A, such as triggering communication to another device or process. For example, if gas consumption of a boiler at a premises is classified as high the classification at block 47 may trigger a communication to a system which schedules maintenance inspection at the premises. If utility consumption is classified at block 47 as low, this may trigger communication to a billing system which makes a financial credit/rebate to the customer account. Another possibility is a physical energy management action. For example, an action could be taken to limit/constrain or de-limit/un-constrain capacity by sending a message to an automated meter based on the class identifier assigned at block 47.

The classification assigned at block 47 may be used to trigger further data analysis 49B of the utility consumption data. For example, consumption which is classified as high or very high may trigger further data analysis of the utility consumption data to determine a cause of the high consumption, such as determining which appliance at the premises contributed an unusually high consumption.

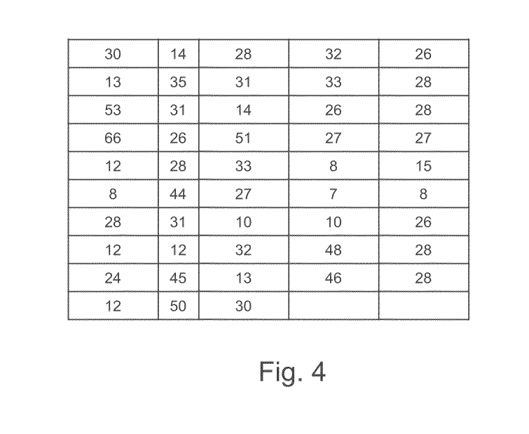

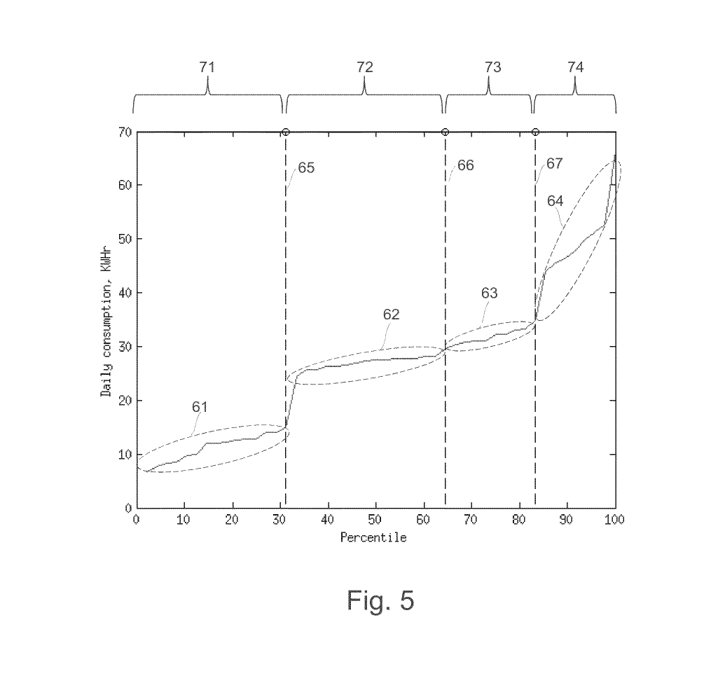

FIGS. 4 and 5 show an example of applying the method of FIG. 3 to data. FIG. 4 shows an example set of 48 utility consumption metric values, where each metric value represents utility consumption at one of 48 different consumer premises. The set of metric values in FIG. 4 are unordered. Each metric has been derived from a consumption/load profile as described above and can represent an aspect of consumption over a single time period or across multiple time periods within a larger time frame. In this example, the metric values represent daily consumption in KWhr. FIG. 5 shows the resulting data after performing the method of FIG. 3. FIG. 5 shows a plot of a sorted set of the 48 metric values. The metric values are shown as a two-dimensional array of data, with the consumers distributed along the x-axis and metric values along the y-axis. In this example there are four clusters of metric values 61, 62, 63, 64. Boundaries 65, 66, 67 are defined between the clusters 61, 62, 63, 64. Boundary 65 is defined between clusters 61 and 62; boundary 66 is defined between clusters 62 and 63; boundary 67 is defined between clusters 63 and 64. The classes are defined by the boundaries. The boundaries in this example define percentile values of the set of consumers. A first class 71 is defined between the 0 percentile and boundary 65; a second class 72 is defined between boundaries 65 and 66; a third class 73 is defined between boundaries 66 and 67; and a fourth class 74 is defined between boundary 67 and the 100^{th} percentile. The metric value of each of the 48 consumers falls into one of the classes 61, 62, 63, 64. Additionally, or alternatively, the method can identify boundaries between clusters in terms of metric value. In this example the first boundary 65 is found between consumers with consumption values 15 kWhr and 24 kWhr. This corresponds to the first dividing line at percentile˜31. Percentile bounds are calculated in a similar manner. Similar calculations can be made for each separate boundary.

The boundaries 65-67 between the clusters 61-64 of the sorted utility consumption metrics define different classes 71-74 of utility consumption by the consumers and divide the consumption metrics of the consumers into the different classes 71-74. One of the classes can represent an efficient consumer. For example, class 71 can represent an efficient consumer. The boundary 65 between class 71 and class 72 can be defined as the benchmark for an efficient utility consumption behaviour. Depending on the type of metric, the most efficient class may be associated with the lowest metric values (as in the example of FIG. 5, where the metric represents mean consumption) or the highest metric values. An example of a metric where the higher metric value indicates a more efficient household could be a trending metric such as ‘average reduction in daily energy use’.

The method of FIG. 3 dynamically assigns boundaries based on the metric values. This contrasts with a scheme where boundaries are static.

There are some possible options for the number of clusters/classes formed by the method of FIG. 3. In a first option, the number of clusters/classes can be predetermined, but configurable. For example, the method can be configured with N classes (e.g. N=4, representing low, below average, above average and high consumption.) The value of N may be set in advance. The value of N can be set by a system administrator. This finds N clusters and N classes from a data set. However, the boundaries of those clusters/classes are determined automatically from the data set by the processing system. The boundaries are not fixed in advance. In a second option, the number of classes/clusters is automatically determined by the processing system. The number of cluster/classes is variable and determined automatically from the data set by the processing system, and the boundaries of those clusters/classes are also determined automatically from the data set by the processing system. The number of boundaries between clusters is the number of clusters minus 1, i.e. N−1.

The output of the processing system can be considered as pairs of data where the two items are a consumer identifier and a classification, e.g. [Consumer, Classification] of [A, Low], [B, Low], [C, medium] . . . and numerical values describing the boundaries of clusters, including the value describing an efficient level of consumption, e.g. [Low, 0-10], [Medium, 10-20], etc.

Referring again to FIG. 3, the utility consumption data and/or utility consumption metrics can be associated with metadata. The metadata can: (i) associate the consumer to a particular group of consumers or (ii) define the consumer in terms of one or more descriptive variables such as: age; gender; geographic location; employment type; property construction material. If the metadata is as per item (ii), the metadata can be used to assign the consumer to a group of users who have similar descriptive variables, for example a series of users described as being of the same age, employment type and geographic location. Where the data is associated to metadata and the consumers assigned to groups, the clusters and classification of data output at block 48 is for a particular consumer group.

The method described above is applied to a set of metrics. The set comprises a single metric per consumer. It is also possible to determine a plurality of different metrics per consumer. Each of the metrics is indicative of a different aspect of consumption by one of the plurality of consumers over a time period, such as: a metric indicative of mean consumption over a time period; a metric indicative of total consumption over the time period; a metric indicative of variance of consumption over the time period; a metric indicative of a time of peak consumption etc. The method described above can be repeated for each of the different metrics.

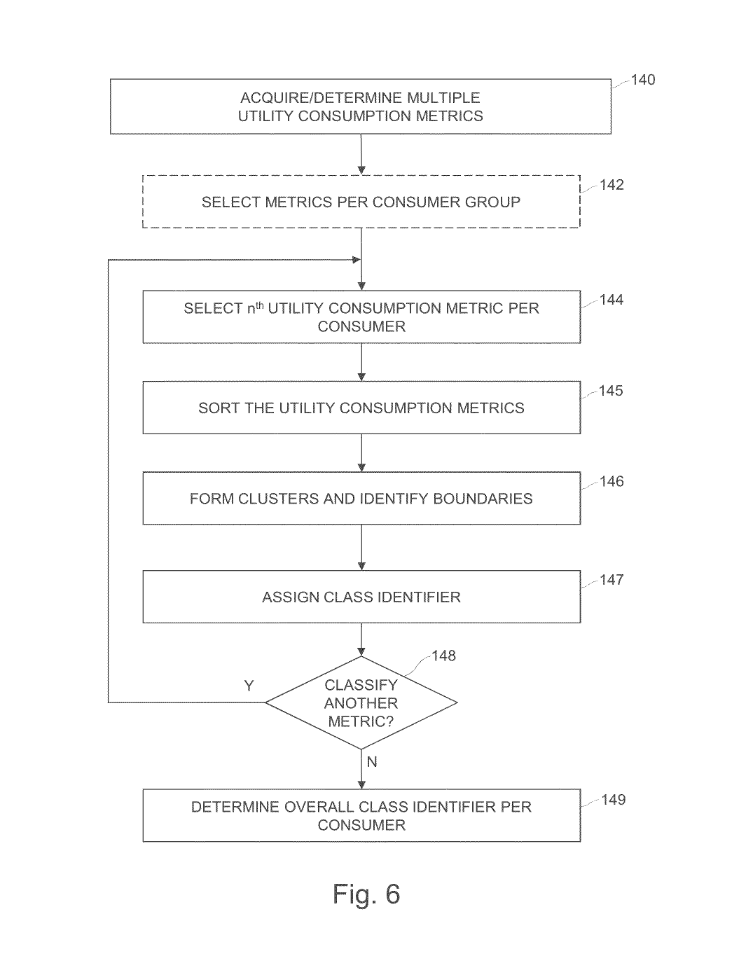

FIG. 6 shows an example method which uses multiple metrics per consumer. The initial block 140 is the same as block 40 of FIG. 3, except that it acquires, or determines, multiple utility consumption metrics per consumer. For example, a plurality of metrics (e.g. metric 1, metric 2) per consumer indicative of utility consumption. Block 144 selects the nth utility consumption metric per consumer to form a data set. For example, the first iteration of this method can select a first metric (metric 1) for each of the plurality of consumers. Blocks 145, 146 and 147 are the same as blocks 45, 46 and 47 of FIG. 3. Block 147 assigns a class to each of the first metrics. Block 148 checks if there are any other metrics to classify. If there are further metrics to classify, the method returns to block 144. The next metric is selected per consumer. For example, the second iteration of this method can select a second metric (metric 2) for each of the plurality of consumers. The metrics are classified by blocks 145, 146 and 147. Block 147 assigns a class to each of the second metrics. The method repeats until all metrics are classified in this way. The method can use two metrics per consumer, or any larger number of metrics per consumer. When all metrics have been classified, the method proceeds to block 149. Block 149 determines an overall class of utility consumption per consumer based on the individual classes of utility consumption assigned to each of the plurality of metrics per consumer. Consider an example with three consumers (A, B, C). A first metric (e.g. weekday consumption) may classify the consumption of these consumers as (Low, Medium, High). A second metric (e.g. weekend usage) may classify the consumption of these consumers as (Low, Medium, High) etc. The overall, higher-level, classification of the consumers uses the results of these lower level classifications. For example, if Consumer A has classifications of Low weekday consumption and High weekend consumption, they may be classed further as ‘Weekend Bias’. This classification may be rules based.

Any of the examples described above can be applied to a metric which represents an aspect of consumption of a single utility (e.g. just electricity), to a metric which represents an aspect of consumption of more than one utility, or to a metric which represents an aspect of consumption of one utility in comparison to one or more other utilities. For example, utility consumption data may be determined for a plurality of different utilities, such as electricity and gas. A total energy consumption can be determined by combining gas and electricity consumption. Any of the metrics described above may be applied to the combined utility consumption data, such as: an amount of combined consumption in a time period; variance of combined consumption across multiple time periods within a larger time frame; ratio of combined consumption between time periods within a larger time frame; time period of combined consumption within a larger time frame; a rate of change of combined consumption across multiple time periods within a larger time frame. In another example, a metric may represent a ratio of consumption of a first utility to a second utility in a time period (e.g. ratio of gas consumption to electricity consumption). Another example is a metric which represents a proportion of total utility consumption in a time period which is a particular utility, such as a proportion of total utility consumption on a Tuesday which is gas.

One clustering technique will now be described in more detail. The k-means algorithm is a method used to classify a set of points (observations) into distinct classes. The goal is to partition the input points into K distinct sets (clusters). K-means is a hard assignment algorithm in which membership of each observation to a cluster is a boolean (i.e., it is true or false). K-means is a partitioning algorithm. The partitioning works by minimising a cost function, the sum over all clusters of the within-cluster sums of the distance of each point to the cluster centroid. The algorithm then proceeds iteratively, by updating the points of the centroids based on the means of each cluster. It proceeds as follows:
Given an initial set of k centroids, assign each observation to the cluster that yields the least within-cluster sum of squares: the distance of each point to the cluster center.
Update the position of the k centroids.
Repeat the assignment based on the new centroid position.
Iterate until convergence, or until a maximum number of iterations is reached.

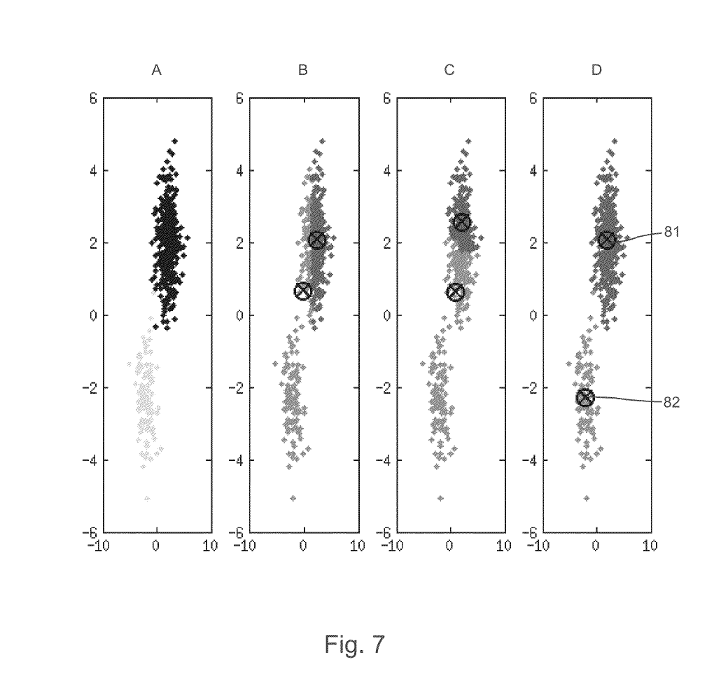

FIG. 7 shows an example of K-means algorithm on a set of data. Plot A shows a set of data points described against two dimensions. Visually it can be seen that there are two main clusters of data points, as indicated in the Plot. Plot B shows assignment of data points to centroids after one iteration of the k-means algorithm. Plot C shows assignment after two iterations. Between the first iteration (Plot B) and second iteration (Plot C), the centroids change position based on the new assignment. Plot D shows assignment after 100 iterations. After 100 iterations, the algorithm has converged. The final centroid positions of the two clusters are shown as 81 and 82.

In the examples of FIG. 5 and FIG. 7, two-dimensional data is used to more clearly illustrate the clustering. However, k-means can be applied to one dimensional data, or to multi-dimensional data. In FIG. 5, the metric values are shown as a two-dimensional arrangement, with metric value (vertical axis) and percentile value (horizontal axis). In a one dimensional example, a data set of metric values (e.g. the table of FIG. 4) can be sorted along a 1D axis representing increasing/decreasing metric value. In visual terms, each member of the data set is placed on the axis at a point corresponding to the value of that member. This creates clusters of data points and gaps or, to describe another way, regions on the axis where there are higher and lower densities of data points. The higher density regions of dots correspond to the clusters, and gaps correspond to the boundaries. The boundaries represent metric values.

Other clustering techniques, which can be used instead of k-means are:
Gaussian expectation-maximization: this uses a similar iterative algorithm to k-means except assigning a probabilistic interpretation. This technique assumes each cluster is a Gaussian, and calculating the probability of each point belonging to each Gaussian.
Fuzzy-kmeans: This technique is similar to k-means except it is modified in that each observation can belong to all clusters, with a weight assigned to each.
Threshold gradient difference: when there is a large step difference in the metric values, this technique assigns consumers to a new cluster. This is equivalent to finding the points of inflexion in a sorted plot of consumption levels.

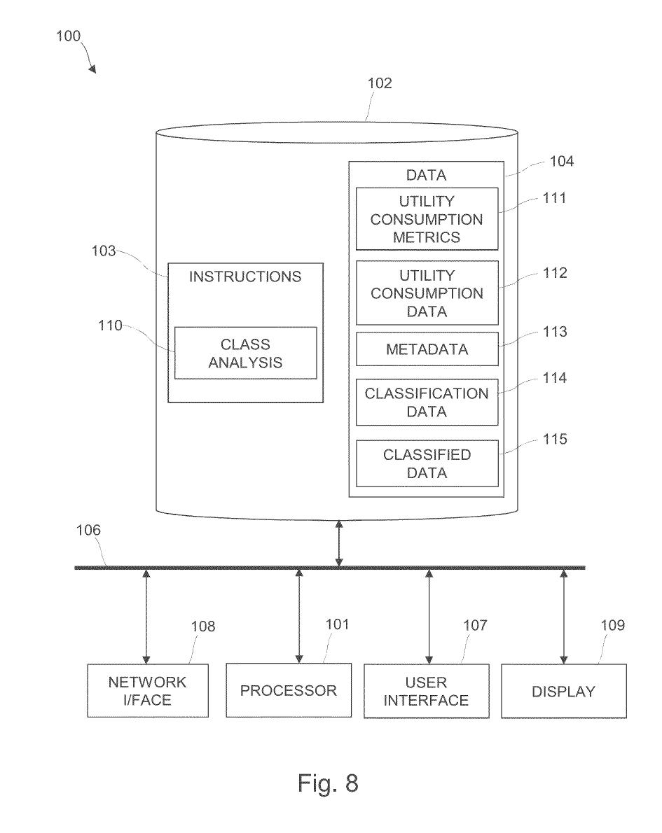

FIG. 8 shows an exemplary processing apparatus 100 which may be implemented as any form of a computing and/or electronic device, and in which embodiments of the system and methods described above may be implemented. Processing apparatus 100 can be provided at the data center 15, or at some other part of the system of FIG. 1. Processing apparatus 100 may implement the method shown in FIG. 3 or FIG. 6. Processing apparatus 100 comprises one or more processors 101 which may be microprocessors, controllers or any other suitable type of processors for executing instructions to control the operation of the processor. The processor 101 is connected to other components of the device via one or more buses 106. Processor-executable instructions 103 may be provided using any computer-readable media, such as memory 102. The processor-executable instructions 103 can comprise instructions for implementing the functionality of the described methods. The memory 102 is of any suitable type such as read-only memory (ROM), random access memory (RAM), or a storage device of any type such as a magnetic or optical storage device. The memory 102, or an additional memory, can be provided to store data 104 used by the processor 101. The data 104 comprises: utility consumption metrics 111; utility consumption data 112; metadata 113; classification data 114 (e.g. class labels); and classified data 115 (e.g. customer identifiers and their associated classification; and numerical values describing the boundaries of clusters). The processing apparatus 100 comprises one or more network interfaces 108 for interfacing with other network entities. For example, a network interface 108 allows the apparatus 100 to receive utility consumption data or utility consumption metrics from utility consumption meters 12. The processing apparatus 100 also comprises a user interface 107 configured to receive input from a user. The processing apparatus 100 may also comprise a display device 109 which can be separate from, or integrated with, the user interface 107.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A method of classifying consumption of at least one utility by a plurality of consumers, the method comprising:
acquiring or determining a plurality of utility consumption metrics, wherein each utility consumption metric comprises a value which is indicative of an aspect of consumption by one of the plurality of consumers over a single time period or across multiple time periods within a larger time frame;
sorting the plurality of utility consumption metrics according to metric value; and
forming clusters of the sorted utility consumption metrics to identify boundaries between the clusters of the sorted utility consumption metrics,
wherein the boundaries between the clusters of the sorted utility consumption metrics define different classes of utility consumption by the consumers and divide the consumption metrics of the consumers into the different classes.

2. A method according to claim 1 wherein the acquiring comprises:
receiving utility consumption data for a plurality of consumers; and
calculating utility consumption metrics based on the utility consumption data, wherein each utility consumption metric comprises a value which is indicative of an aspect of consumption by one of the plurality of consumers over a single time period or across multiple time periods within a larger time frame.

3. A method according to claim 1 further comprising notifying the consumers of the class of their utility consumption metric.

4. A method according to claim 1 further comprising performing an action for a consumer based on the class of the consumer's utility consumption metric.

5. A method according to claim 1 further comprising:
designating one of the boundaries as a benchmark consumption.

6. A method according to claim 5 further comprising performing additional processing for a consumer based on the class of the consumer's utility consumption metric relative to the benchmark consumption.

7. A method according to claim 6 further comprising performing analysis of utility consumption data based on the class of a consumer's utility consumption metric relative to the benchmark consumption.

8. A method according to claim 1 wherein forming clusters uses an unsupervised learning algorithm.

9. A method according to claim 8 wherein forming clusters uses K-means clustering.

10. A method according to claim 1 further comprising applying a class identifier to each class of the utility consumption metrics.

11. A method according to claim 1 wherein the utility consumption metric is indicative of one of:
an amount of consumption in a time period;
variance of consumption across multiple time periods within a larger time frame;
ratio of consumption between time periods within a larger time frame;
time period of consumption within a larger time frame;
a rate of change of consumption across multiple time periods within a larger time frame;
ratio of consumption between different utilities in a time period; or
proportion of total utility consumption in a time period of a particular utility.

12. A method according to claim 1 further comprising initially identifying a group of consumers, wherein the plurality of utility consumption metrics are for the group of consumers.

13. A method according to claim 1 further comprising:
acquiring or determining a plurality of utility consumption metrics per consumer, wherein each utility consumption metric comprises a value which is indicative of a different aspect of consumption by the consumer over a single time period or across multiple time periods within a larger time frame,
wherein the sorting of the plurality of utility consumption metrics and the forming clusters of the sorted utility consumption metrics is performed for a data set comprising a first of the utility consumption metrics per consumer to derive classes of utility consumption for the first metrics, and repeated for a data set comprising a second of the utility consumption metrics per consumer to derive classes of utility consumption for the second metrics.

14. A method according to claim 13 further comprising determining an overall class of utility consumption per consumer based on the class of utility consumption for the first metric and on the class of utility consumption for the second metric.

15. A method according to claim 1 wherein the utility is at least one of: electricity, gas and water.

16. Apparatus for classifying consumption of at least one utility by a plurality of consumers, the apparatus comprising a processor and a memory, the memory containing instructions executable by the processor whereby the processor is operative to:
acquire or determine a plurality of utility consumption metrics, wherein each utility consumption metric comprises a value which is indicative of an aspect of consumption by one of the plurality of consumers over a single time period or across multiple time periods within a larger time frame;
sort the plurality of utility consumption metrics according to metric value;
form clusters of the sorted utility consumption metrics to identify boundaries between the clusters of the sorted utility consumption metrics,
wherein the boundaries between the clusters of the sorted utility consumption metrics define different classes of utility consumption by the consumers and divide the consumption metrics of the consumers into the different classes.

17. A computer program product comprising a machine-readable medium carrying instructions which, when executed by a processor, cause the processor to:
acquire or determine a plurality of utility consumption metrics, wherein each utility consumption metric comprises a value which is indicative of an aspect of consumption by one of the plurality of consumers over a single time period or across multiple time periods within a larger time frame;
sort the plurality of utility consumption metrics according to metric value; and
form clusters of the sorted utility consumption metrics to identify boundaries between the clusters of the sorted utility consumption metrics,
wherein the boundaries between the clusters of the sorted utility consumption metrics define different classes of utility consumption by the consumers and divide the consumption metrics of the consumers into the different classes.
